(19) United States
(12) Patent Application Publication
(10) Pub. No.: US 2023/0032052 A1
(43) Pub. Date: Feb. 2, 2023

(54) NANOFIBER BEARING PERMEABLE FILTER LAMINAE

(71) Applicant: ULTRA SMALL FIBERS, LLC, Wartrace, TN (US)

(72) Inventors: William H. Hofmeister, Nashville, TN (US); Robert A. Van Wyk, St. Petersburg, FL (US); Collin D. Anderson, Arlington Heights, IL (US)

(21) Appl. No.: 17/386,522

(22) Filed: Jul. 27, 2021

(51) Int. Cl. B01D 39/16

(52) U.S. Cl. CPC B01D 39/1623; B01D 2239/025; B01D 2239/0659; B01D 2239/0654

(57) ABSTRACT

A filter media construct includes a plurality of flexible laminas joined in a stack, each lamina including an array of nanofibers extending from a surface thereof. Each lamina is configured to be permeable to a fluid such that the fluid can flow through each lamina normal to the surface thereof and in any direction along at least a portion of said surface when the fluid is flowed through the construct. The laminas can include a plurality of perforations extending therethrough such that the fluid flows through at least some of the perforations of the laminas when the fluid is flowed through the construct. A contaminant contained in the fluid is at least partially filtered from the fluid by the nanofibers when the fluid is flowed along the surface of any lamina or into or through the perforations.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING OR COMPUTER PROGRAM LISTING APPENDIX

Not Applicable.

### BACKGROUND OF THE INVENTION

The present disclosure relates generally to filter media and filter devices, and more specifically to filter media and filter devices which combine user-defined arrays of nanofibers and permeable sheet-like elements to create filter media that provide the benefits of nanofibers in a form that can be utilized in ways similar to conventional filter media.

Fibrous filter media are used in various types of filter devices to trap large and small particles in liquid and gas streams. Such filter media are typically formed from multiple layers of coarse and fine fibers extending parallel to an upstream surface of the filter media. An outer layer of coarse fibers forms a bulk filtration layer for filtering of larger particles, while an inner or underlying layer of fine fibers provides filtering of small particles. Fine fibers are often provided in a thin layer laid down on a supporting permeable substrate or used with one or more permeable protective layers to obtain a variety of benefits, including increased efficiency, reduced initial pressure drop, cleanability, reduced filter media thickness, and to provide a selectively impermeable barrier to various liquids, such as water. However, prior approaches have several inherent disadvantages, including the need for a supporting substrate, a risk of delamination of the fine fiber layer from the substrate, more rapid loading of the filter by captured particles, the alignment of fine fibers parallel to the media surface, and an inability to control spacings between fine fibers.

In addition to filtering mechanisms, on the molecular level, fibrous materials also trap contaminants with electrostatic forces, including ionic bonding, hydrogen bonding, and Van der Waals forces. These electrostatic interactions occur on the fiber surface. Because these interactions are known to increase non-linearly at sub-micron length (diameter) scales, functional improvement in fibrous filter media is largely based on minimizing denier (linear mass density or fiber diameter). Although the production of filter media comprising very fine fibers having a high surface-to-volume ratio, such as microfibers and nanofibers, has recently been emphasized in the industry, processing limitations associated with traditional methods of producing such fibers limit the utility of these materials in filtration applications.

The benefits realized through the use of nanofibers for filtering contaminants from a fluid stream are well known, and the technology is widely used. As currently commonly practiced, a thin layer of electrospun or melt-blown nanofibers is deposited (e.g., laid down in a pile) on a porous substrate. Nanofibers deposited using these processes form a non-woven mat that lacks physical strength. This makes handling of prior art nanofiber mats without a suitable permeable substrate impractically difficult for filter manufacturing. The unique filtering properties of a nanofiber mat derive from the diameter of the nanofibers, and these properties are currently only obtainable with fibers formed into these non-woven constructs. Filter media formed of micro-fibers are easily handled during filter manufacturing, but because of their larger diameter, the fibers lack the enhanced filtering abilities of nanofibers. Accordingly, to achieve these enhanced properties in a filter, nanofibers are commonly deposited onto microfiber media in the manner previously described.

Nanofibers for prior art filter applications are commonly made by electrospinning, a method that requires the use of high voltages and a flowing polymer solution containing solvents that evaporate during production. Ensor, et al. in U.S. Pat. No. 8,652,229 describe methods for electrospinning nanofibers and forming filter elements therefrom. In the methods described, the electrospinning process requires electrical potentials in the 25 kV to 30 kV range and the close control of several process parameters. The rates of nanofiber production are low in the examples given. When forming nanofibers by electrospinning, the nanofiber materials are limited to polymers that can be mixed with a solvent to achieve the properties required for the process. It is not an environmentally friendly process due to the solvents required. Electrospinning produces an interconnected web (or mat) of continuous small fibers with length to diameter ratios generally 1,000,000:1 or greater.

In electrospinning, the fibers of a closely controlled diameter are deposited onto a substrate. The substrate may be a flat plate oriented normal to the axis of the origin of the solution stream. Alternatively, the substrate may be a rotating element with a cylindrical, conical or other radially symmetric shape, the axis of rotation being perpendicular to the axis of the solution stream. Or the substrate may be a rotating disc with the axis of rotation parallel to the axis of the solution stream. Each of these substrate forms allow the forming of fiber webs or mats configured to achieve specific design objectives through optimizing the deposition pattern of the fibers. If translation of the substrate in a plane normal to the solution stream is added to any of the substrate configurations, the deposited fiber may be given a directionality. Indeed, the fiber mat may be formed with a predetermined pattern to achieve design objectives for a given application. Microfiber or nanofiber webs or mats with a particular preferential orientation of the fibers are frequently referred to as “ordered”, and in some cases an “ordered matrix”, or “ordered construct”. The “order” to which this refers, then, is that the elongate continuous fibers forming the mat do not have a random directionality, but rather have a greater portion oriented parallel to a first axis than to a second axis. This is a two-dimensional effect only since the fiber web or mat forms a thin sheet, which is frequently membrane-like due to the fibers being laid down on the surface of the surface.

Prior art nanofiber mats cannot withstand tensile loading. Because nanofibers forming the mat have very low structural strength, increasing the number nanofibers does not appreciably increase the thickness of the mat, but simply creates a denser mat with decreased porosity. When the nanofiber mat manufactured by the electrospinning method is used to form an air filter, nanofibers can be easily clogged (that is, packing can easily occur), resulting in a decrease in air permeability and an increase in pressure loss. Since clogging can easily occur, there have been problems in that the pressure loss may easily increase and the service life of an air filter may be shortened.

To address these drawbacks, Konishi, in US Patent Application Publication No. 2018/0353883 discloses an alternate method (not electrospinning) for forming a non-woven mat of nanofibers. Konishi's method forms a mat of fibers that have a range of diameters that average less than one micron, but that contains fibers of larger diameters so as to give the mat increased thickness and spacing between the nanofibers. The number of fibers having fiber diameters ranging from 2 times up to 10 times the average fiber diameter of the constituent fibers is in a range of 2 to 20% of a total number of the constituent fibers. The fiber mat is deposited onto a non-woven fabric using a complex process. Although the thickness of the mat is somewhat increased, the long continuous fibers are randomly deposited in a two-dimensional construct similar to electrospun mats.

Microfibers for filters and other applications may be made by melt blowing, a fiber making process in which melted polymer is extruded through a plurality of small orifices surrounded by streams of a high velocity gas. A plurality of randomly oriented fibers are deposited onto a substrate so as to form a non-woven mat or fabric. The process does not require the use of solvents or high voltages, and the fiber deposition rates can be orders of magnitude greater than those possible by electrospinning. Melt blown fibers are generally in the range of two to five microns with a wide diameter distribution. Because the fibers are not drawn to a substrate by an electrostatic charge as in electrospinning, fiber mats formed by melt blowing are not membrane-like, but rather have fibers that are spaced one from another in the direction parallel to the blowing direction. The fibers are long and continuous with a random orientation. In some applications the mat is subsequently compressed to form a non-woven fabric. Melt blowing nanofibers is difficult since extremely small orifices are required and the molten plastic must flow through these orifices and remain in fiber form as they travel to the substrate. Surface tension in the molten fiber tends to cause the material to become droplets rather than fibers so as to reduce the surface energy. Accordingly, the polymers that can be successfully melt blown into nanofibers is limited and the process has not yet been scaled up sufficiently for commercial use. The process remains an efficient method for forming microfiber mats and non-woven fabrics for filters and other applications.

In another approach, increasing the nanofiber content of a filter is accomplished through the use of a stratified filter construction with layers of nanofibers interspersed between microfiber substrate layers.

Whether a nanofiber mat is formed by electrospinning, Konshi's method, or another means, the mat is a thin construct, which is frequently membrane-like. Because of this, the mat is oriented essentially normal to the flow stream direction during use in filtration. The density of the mat is limited by the backpressure that the filtering process can tolerate.

The beneficial effects of including nanofibers in a filter may be temporarily enhanced by electrostatically charging the nanofibers. For instance, it has been demonstrated that charging nanofiber mats interspersed between insulating separating permeable layers causes a significant increase in the filter efficiency. This is described in detail in US Patent Application Publication No. 2019/0314746 by Leung. However, the applied electrostatic charge degrades over time so that filters of this type have a finite shelf life, making them impractical for some applications.

Polymeric materials have an inherent electrostatic charge that creates an attractive force, the force at any given point on a surface being inversely dependent on the radius of curvature of the external surface at that point. When the radius of curvature is large the electrostatic attractive force is weak. As the radius is decreased the attractive force increases, a factor exploited in nanofiber filter media. The small diameter of the nanofibers results in an attractive force that is orders of magnitude greater than that of microfibers allowing nanofibers to draw contaminant particles with greater force for removal from a fluid stream. This electrostatic charge is intrinsic to the material and does not degrade in the manner of an applied electrostatic charge.

Filters for use in personal protective equipment (PPE) may also benefit from the inclusion of nanofibers. Specifically, face masks that form a tight seal to the face, also referred to as respirators, are commonly used to prevent contaminants from entering the airway of the wearer. These devices reduce the wearer's exposure to particles including small particle aerosols and large droplets. Face masks of this type must remove contaminants while minimizing the pressure drop across the filter element. The filtering element forming the mask may also be pliable so as to allow the mask to form a seal with the face of the wearer. Typically a wearable filter of this type will have a permeable hydrophobic outer protective layer, a coarse filter media layer for removing large particulate, a fine filter medial layer for removing smaller particulate, and an inner soft permeable fabric layer for contacting the face of the wearer.

Leung in U.S. Pat. No. 8,303,693 teaches a face mask that incorporates a filtration. medium which includes a fine filter layer having a plurality of nanofibers and a coarse filter layer having a plurality of microfibers attached to the fine filter layer. flow passes through the coarse filter to the fine filter layer. The polymer nanofibers in the fine filter layer may he obtained in a variety of ways including electrospinning or by melt-blowing. Accordingly, the nanofibers are long and continuous with a random orientation. The thickness of this nanofiber layer may have a thickness of about 0.01 to about 0.2 millimeters. Because the nanofiber fine filter layer is a thin layer, the layer may tend to dog easily and increase the resistance to air flow. The coarse and fine layers together form a “well-bonded laminate structure”, the layers being bonded one to another. Indeed, it is necessary for the nanofiber layer to be bonded to the microfiber layer for handling purposes during manufacture of a filter since the nanofiber layer lacks physical strength. in one embodiment the nanofibers are deposited onto the microfiber layer during electrospinning or melt blowing so that they adhere to the microfiber layer. In another embodiment the nanofibers are deposited onto a liquid in which the microfibers are submerged so that the nanofibers are not adhered to the microfibers. When forming of a nanofiber layer is complete, the liquid is removed leaving the nanofiber layer atop the microfiber layer but not adhered thereto. The nanofiber layer and microfiber layer are then compressed mechanically together with a small amount of compatible adhesive to form a rigid structure. The manner in which Leung's layered filter assembly is formed illustrates the difficulty and limitations of forming filter assemblies incorporating electrospun and melt blown nanofibers due to their mechanical properties. As with other applications that incorporate electrospun nanofibers, the fiber making process is difficult to scale up and is environmentally undesirable due to the solvents used. The integration of nanofibers into a mask assembly is similarly difficult.

Hofmeister, et al. in U.S. Pat. No. 10,159,926 teaches media and devices for filtering or separating a contaminant from a fluid liquid or gas stream. The Hofmeister devices incorporate flow passages formed by layered laminas comprising tunable topographies of user-defined arrays of nanofibers and, optionally, nanoholes. These tunable nanofiber topographies selectively remove contaminants from the fluid stream as it flows through spaces between adjacent laminas, parallel to the surface of the laminas, with at least one of these surfaces having nanofibers formed thereon. Contaminants are drawn to the nanofibers by electrostatic forces in the manner previously described. Nanofiber filters constructed in accordance with the Hofmeister patent can be tuned to remove specific contaminants such as pathogens, chemical contaminates, biological agents, and toxic or reactive compounds from a fluid to be filtered by selecting a suitable nanofiber diameter, height, distance between nanofibers, interlaminar gap and material.

The Hofmeister filter construction requires a rigid housing to maintain the orientation and alignment of the laminas making up the filter so that a continuous flow path is created between an inlet and outlet formed in the housing, the flow passing through interlaminar spaces formed therein. Accordingly, applications for the Hofmeister filter with its tuned topography are limited to those in which the fluid stream is directed through spaces formed between adjacent, aligned laminas, the alignment being maintained by a rigid housing structure. Because of this, the benefits of filter elements comprising a tuned topography formed of nanofiber arrays cannot be realized in filtering devices that do not/cannot include a rigid housing and flow between adjacent parallel laminas.

Hofmeister et al., in U.S. Pat. No. 11,014,029 teaches filter media made up of elongate filter ribbons with a flexibly planar film portion with arrays of nanofibers formed on a surface thereof. The ribbons may be formed into mats or non-woven fabrics, or may be confined within a cavity of a filter housing. The non-woven fabrics or mats may be part of a filter construct formed of layers of differentiated filter media configured to remove contaminants of increasingly smaller sizes, with filter ribbons of the invention being preferably in the downstream-most portion of the construct. Additionally, because the nanofiber arrays of the ribbons may have topographies that are tuned to remove specific contaminants, successive layers of filter ribbons may be configured to each remove a specific contaminant from the fluid stream. While the ribbons taught by Hofmeister may be formed into a sheet of non-woven fabric, there remains a need for a filter media with the benefits of nanofiber arrays that is formed as a monolithic sheet.

There is a need for filter media that exploit the inherent electrostatic properties of nanofibers in optimized configurations that do not require a rigid housing and rigidly parallel laminar construction. Such media are the subject of this invention.

Accordingly, it is an object of the present invention to provide nanofiber filter media that can withstand tensile loading.

It is also an object of the present invention to provide nanofiber filter media that achieve high collection efficiency and reduced clogging (packing) between fibers.

It is also an object of the present invention to provide nanofiber filter media that does not require deposition on a substrate during manufacture.

It is also an object of the present invention to provide nanofiber filter media wherein the nanofibers are configured to optimally exploit the electrostatic properties of the nanofibers.

It is also an object of the present invention to provide nanofiber filter media wherein the nanofibers cannot be easily expelled from the filter media.

It is also an object of the present invention to provide nanofiber filter media wherein the nanofibers are integrated in a laterally extending, flexible, sheet-like, perforated structure.

It is further an object of the present invention to provide nanofiber filter media at lower cost than current nanofiber media.

It is further an object of the present invention to provide nanofiber filter media that may be produced without the need for high voltages or environmentally detrimental solvents.

It is also an object of this invention to provide a method for increasing the wettability of a fluid on a surface of filter media through the formation of nanofibers on one or more surfaces of the media.

It is further an object of this invention to provide a method for decreasing the wettability of a fluid on a surface of filter media through the formation of nanofibers on one or more surfaces of the media.

It is an object of this invention to provide a method of selectively increasing the wettability of a surface of a filter media for a first flow stream component while decreasing the wettability for a second flow stream component.

It is also an object of this invention to provide nanofiber filter media that can remove biological contaminants including viruses from an air stream.

### BRIEF SUMMARY

These and other objects are achieved in devices and methods of the present invention which addresses filter media, filtering devices formed therefrom, and methods for their use wherein the filter media is formed of perforated flexible laminae with tuned arrays of nanofibers formed on a surface thereof.

The laminae of filter media of the present invention are formed of a suitable polymeric film, have a flexible planar portion of predetermined thickness and width, and have an array of nanofibers formed on at least one surface of the film. In a preferred embodiment the nanofibers are arranged in rows spaced a first distance apart, with the nanofibers within each row spaced a second distance apart. In some embodiments the first and second distances are equal. In others they are not. The diameter of each nanofiber generally decreases along the nanofiber's length from a first diameter at its base, and the lengths of the fibers in an array fall within a predetermined range. The form of a fiber is largely determined by the ratio of the length of the fiber to its diameter. At low ratios the fiber may have a post-like appearance, while at high ratios the fiber may be tendrilous. Between these extremes is a continuum of nanofiber configurations that share the common characteristic of decreasing diameter over their finite length. Because the electrostatic force at a point on a surface is inversely related to the radius of curvature of the surface at that point, the electrostatic force on a nanofiber of filter media of the present invention is not constant along its length. The electrostatic force generally increases with the general distal reduction in diameter, reaching its maximum at the fiber's distal end. In certain embodiments the ends of the nanofibers are configured to further enhance the electrostatic potential. The electrostatic force of nanofibers formed on laminae of the present invention has maximal intensity at the distal portions of the nanofibers—the portion that is most exposed to the fluid stream. This concentration results in much higher attractive forces to contaminants in the fluid stream than the uniform-diameter, continuous fibers of non-woven nanofiber mats previously herein described and currently in use in filter applications. Because of this, nanofiber arrays formed on laminae of the present invention are able to draw contaminants from a flow stream with higher field gradients than other, prior art, nanofiber filter elements. Laminae of the present invention are also permeable so that flow can occur not only parallel to the plane of the lamina but also through the plane of the lamina. In some embodiments, permeability is achieved through formation of pores in the laminae using non-mechanical means. In additional embodiments, the laminae have perforations mechanically formed therein. In certain embodiments, nanofiber arrays extend into one or more of the perforations in a lamina.

The non-random placement of nanofiber tips in a nanofiber array represents a significant enhancement over nanofiber structures produced by other methods, such as electrospinning, because each fiber forming an array of nanofibers described herein has an independent “end” or “tip.” The “ends” or “tips” of the nanofibers have stronger field gradients than the body of the fibers because gradients are enhanced with curvature and the curvature is highest at the tip. Thus, the use in filter devices of nanofiber arrays having millions of tips per square centimeter of lamina surface preserves and enhances the local fiber field gradient far better than traditional fibrous filter media and devices which rely on layered mats of fibers laid down on a substrate.

Filter laminae of the present invention have appreciable physical strength. Structures formed of them may be handled independent of a substrate, and indeed, make constructs that may be incorporated in a wide range of filter configurations. Mats formed of multiple laminae may be integrated into a single assembly by bonding of the laminae one to another. In a preferred embodiment, multiple laminae are secured in a filter media mat by needling, a procedure in which a needling blade with barbs formed on its periphery is forced through a stack of laminae, the barbs create fibers from the planar film portions that are pierced. These fibers are dragged through successive laminae forming entanglements that affix the laminae one to another.

In some applications a non-woven mat of bonded or loose, turbulence producing fibers or ribbons may be positioned between permeable laminae of the present invention and secured by needling, stitching, or other mechanical means, as well as thermal, chemical or other suitable method. In some preferred embodiments, filter ribbons as taught by Hofmeister, et al. in U.S. Pat. No. 11,014,029 are positioned between permeable laminae, with at least one of the laminae having nanofibers formed thereon in accordance with principles of the present invention.

In a preferred embodiment, laminae incorporate nanofiber arrays with characteristics that impart specific wettability properties. For instance, a permeable lamina may be nominally wetted by a first selected liquid or vapor while nominally not wetted by a second selected liquid or vapor. Laminae with these specific wettability properties may be elements of a filter construct formed by methods previously described herein.

Flexible, permeable, nanofiber bearing laminae of the present invention with the nanofibers formed thereon may be subsequently processed in the same manner as other conventional fibrous media. Because of this, nanofiber filter media of the present invention may be formed into or integrated into filter elements at much lower cost and with much greater design flexibility than prior art, conventionally formed nanofibers made by electrospinning or other similar process. For instance, filter media of sheet form containing a lamina or laminae of the present invention may be formed into pleated elements.

While prior art nanofiber mats formed by electrospinning or other methods form a thin, membrane-like structure, mats formed of permeable laminae of the present invention with arrays of nanofibers formed on a surface thereof are three-dimensional constructs. Laminae may be stacked to create mats of a desired thickness, and may incorporate interlaminar media that filters and creates turbulence thereby increasing the filtering efficiency of the laminae. Mats formed of filter media laminae of the present invention are flexible and resilient. Their pliable nature and low resistance to fluid flow make mats incorporating laminae of the present invention ideally suited for use in personal protective filtering devices used in medical and industrial applications.

Filter media laminae of the present invention with their nanofiber arrays are formed without the use of solvents or high voltage. Specifically, nanofiber arrays of the present invention are formed in a casting process in which a suitable polymer heated to a temperature sufficient to allow flow, is extruded onto a first surface of a mold with an array of nanoholes formed therein, and subsequently flows into the nanoholes of the mold. A surface of a second compressing or quenching element may be used. Subsequently, the polymeric material is cooled sufficiently so that when the compressing element is removed, the polymer with the attached molded nanofibers can be stripped from the mold surface. The result is a planar polymeric film portion with an array of nanofibers integrally formed on a first surface thereof, the form of the nanofiber array being complementary to the nanohole array in the mold. In a preferred embodiment, the mold and second element are rotating cylinders, the polymer in molten form being introduced onto the circumferential surface of the mold, and subsequently compressed between the mold and the cylindrical surface of the second element. This compression enhances the cooling the material so that it can be subsequently peeled from the mold. The resulting film with arrays of integral nanofibers formed thereon is subsequently perforated, the size, distribution, and density of the perforations being optimized for the intended filtering application.

In some embodiments the filter media laminae are formed of a single polymeric material. Others have a layered construction comprising two or more polymeric materials that together give the lamina an optimal combination of filtering properties for a given application, and physical properties for manufacture of the laminae. For instance, nanofiber arrays of a first material may be laminated to a film of a second material with optimal mechanical properties that is formed separately.

In a variation of the previously described casting method for producing film whereon are formed arrays of nanofibers, rather than applying molten polymer to the mold, a polymer film is applied to the mold. The film is then heated to a temperature sufficient to melt or sufficiently soften the material so as to allow the material to flow into nanoholes in the mold. The surface of a compressing element may increase flow of the material into the nanoholes. The polymer is then cooled sufficiently to allow the film with nanofibers formed thereon to be stripped from the mold. As with the previously described casting process, nanofiber bearing films for laminae of the present invention formed using this method may have a layered construction, a second film being compressed against the first, nanofiber forming film by the compressing element so that the films are bonded one to another.

Numerous other objects, advantages and features of the present disclosure will be readily apparent to those of skill in the art upon a review of the following drawings and description of exemplary embodiments.

### BRIEF DESCRIPTION OF THE DRAWINGS

Non-limiting and non-exhaustive embodiments are described with reference to the following figures, wherein like reference numerals refer to like parts throughout the various drawings unless otherwise specified. In the drawings, not all reference numbers are included in each drawing, for the sake of clarity.

FIG. 1A is a first perspective view of a system for making continuous strips of polymer film with nanofiber arrays formed on a surface thereof for permeable laminae of the present invention.

FIG. 1B is a second perspective view of the objects of FIG. 1A.

FIG. 1C is an expanded view of the objects of FIG. 1B at location A.

FIG. 1D is an expanded view of the objects of FIG. 1B at location B.

FIG. 2 is a perspective view of a portion of a film with nanofiber arrays formed on a surface thereof for permeable laminae of the present invention.

FIG. 3 is a plan view of the objects of FIG. 2.

FIG. 4 is a side elevational view of the objects of FIG. 2.

FIG. 5 is an expanded view of the objects of FIG. 4 at location A depicting a first nanofiber configuration for a filter lamina of the present invention.

FIG. 6 is a side elevational view of a second nanofiber configuration for a filter lamina of the present invention.

FIG. 7 depicts the electrostatic field surrounding a nanofiber of FIG. 5.

FIG. 8 depicts the electrostatic field surrounding the nanofiber of FIG. 6.

FIG. 9 is a perspective view of a permeable filter lamina of the present invention.

FIG. 10 is a plan view of the objects of FIG. 9.

FIG. 11 is a side elevational view of the objects of FIG. 9.

FIG. 12 is an expanded view of the objects of FIG. 9 at location A.

FIG. 13 is an expanded view of the objects of FIG. 10 at location B.

FIG. 14 is an expanded sectional view of the objects of FIG. 13 along line A-A.

FIG. 15 is a sectional view of a filter construct incorporating permeable filter laminae of FIG. 9.

FIG. 16 is a perspective view of a system for forming nanofiber bearing film for perforated filter laminae of the present invention.

FIG. 17 is an expanded view of the objects of FIG. 16 at location C.

FIG. 18 is a perspective view of a portion of a permeable filter media construct formed of perforated filter laminae.

FIG. 19 is a plan view of the objects of FIG. 18.

FIG. 20 is a sectional view of the objects of FIG. 19 along line A-A showing the flow of a fluid through the filter media construct.

FIG. 21 is a perspective view of an alternate embodiment perforated filter lamina of the present invention.

FIG. 22 is a plan view of the objects of FIG. 21.

FIG. 23 is an expanded view of the objects of FIG. 21 at location A.

FIG. 24 is an expanded view of the objects of FIG. 22 at location B.

FIG. 25 is a plan view of a portion of an alternate embodiment perforated lamina of the present invention.

FIG. 26 is a perspective view of the objects of FIG. 25.

FIG. 27 is a side elevational view of a portion of an alternate embodiment perforated filter lamina of the present invention.

FIG. 28 is a perspective view of the objects of FIG. 27.

FIG. 29 is a plan view of the objects of FIG. 27.

FIG. 30 is a sectional view of the objects of FIG. 29 along line A-A.

FIG. 31 is a perspective view of nanofiber bearing film with intermittent slits formed therein for forming another alternate embodiment of a permeable filter lamina of the present invention.

FIG. 32 is a perspective view of an alternate embodiment filter lamina of the present invention formed from the film material of FIG. 31 by lateral stretching of the film so as to expand the intermittent slits.

FIG. 33 is a plan view of the objects of FIG. 32.

FIG. 34 is an expanded view of the objects of FIG. 32 at location A.

FIG. 35 is an expanded view of the objects of FIG. 33 at location B.

FIG. 36 is a perspective view of a portion of an alternate embodiment permeable filter lamina of the present invention.

### DETAILED DESCRIPTION

The details of one or more embodiments of the presently disclosed subject matter are set forth in this document. Modifications to embodiments described in this document, and other embodiments, will be evident to those of ordinary skill in the art after a study of the information provided herein. The information provided in this document, and particularly the specific details of the described exemplary embodiments, is provided primarily for clearness of understanding and no unnecessary limitations are to be understood therefrom. In case of conflict, the specification of this document, including definitions, will control.

The present disclosure relates to filter media and devices for removing a contaminant from a fluid stream. In a general embodiment, the nanofiber filters disclosed herein are designed to filter a substance or contaminant from a fluid stream using one or more user-defined arrays of nanofibers, such as those described in U.S. Patent Application Publication No. 2013/0216779 which is incorporated herein by reference in its entirety.

While the terms used herein are believed to be well understood by one of ordinary skill in the art, definitions are set forth herein to facilitate explanation of the subject matter disclosed herein.

Unless defined otherwise, all technical and scientific terms used herein have the same meaning as commonly understood by one of ordinary skill in the art to which the subject matter disclosed herein belongs. Although any methods, devices, and materials similar or equivalent to those described herein can be used in the practice or testing of the presently disclosed subject matter, representative methods, devices, and materials are now described.

To facilitate the understanding of the embodiments described herein, a number of terms are defined below. The terms defined herein have meanings as commonly understood by a person of ordinary skill in the portions relevant to the present invention. The terminology herein is used to describe specific embodiments of the invention, but their usage does not delimit the invention, except as set forth in the claims.

The terms “a”, “an”, and “the” refer to “one or more” when used in this application, including the claims. Thus, for example, reference to “a contaminant” includes a plurality of particles of the contaminant, and so forth. The use of the word “a” or “an” when used in conjunction with the term “comprising” in the claims and/or the specification may mean “one,” but it is also consistent with the meaning of “one or more,” “at least one,” and “one or more than one.”

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and devices of the present disclosure, including components thereof, can comprise, consist of, or consist essentially of the essential elements and limitations of the embodiments described herein, as well as any additional or optional components or limitations described herein or otherwise useful.

This description and appended claims may include the words “below”, “above”, “side”, “top”, “bottom”, “upper”, “lower”, “when”, “upright”, etc. to provide an orientation of embodiments of the invention to allow for proper description of example embodiments. The foregoing positional terms refer to the apparatus when in an upright orientation. A person of skill in the art will recognize that the apparatus can assume different orientations when in use. It is also contemplated that embodiments of the invention may be in orientations other than upright without departing from the spirit and scope of the invention as set forth in the appended claims. Further, it is contemplated that “above” means having an elevation greater than, and “below” means having an elevation less than such that one part need not be directly over or directly under another part to be within the scope of “above” or “below” as used herein.

The phrase “in one embodiment,” as used herein does not necessarily refer to the same embodiment, although it may. Conditional language used herein, such as, among others, “can”, “might”, “may”, “e.g.,” and the like, unless specifically stated otherwise, or otherwise understood within the context as used, is generally intended to convey that certain embodiments include, while other embodiments do not include, certain features, elements and/or states.

Unless otherwise indicated, all numbers expressing physical dimensions, quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about,” when referring to a value or to an amount of mass, weight, time, volume, concentration, percentage or a physical dimension such as length, width, or diameter, is meant to encompass variations of in some embodiments ±20%, in some embodiments ±10%, in some embodiments ±5%, in some embodiments ±1%, in some embodiments ±0.5%, and in some embodiments ±0.1% from the specified value or amount, as such variations are appropriate to perform the disclosed methods.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the term “fluid” is defined as any liquid or gas which can be passed through the filter media and filter devices disclosed herein. Multiple fluids having different specific gravities and viscosities can be used as well as gas and vapor streams, depending on the application.

As used herein, the term “nanofiber” refers to a fiber structure having a diameter of less than 1000 nanometers for more than half the length of the structure. In some embodiments, the nanofibers disclosed herein can comprise a tapered base portion and a relatively longer fiber portion which extends from the base portion. In such embodiments, the fiber portion has a diameter of less than 1000 nm and a length greater than that of the base portion, and the base portion can have a diameter of from about 10 micron to less than 1.0 micron. Additionally, in some embodiments, the base portion can also have a length of from about 1.0 micron to about 10 microns, and the fiber portion can have a length of from about 10 to 100 times greater than the length of the base portion. Nanofibers having larger diameter base portions in the range of from about 2.0 microns to about 10 microns are best suited for applications wherein the bases must provide stiffness to the nanofiber in the fluid stream.

In some preferred embodiments, nanofibers suitable for use in the nanofiber filter media and filter devices disclosed herein can have an overall length of from about 10 to about 100 microns. Accordingly, suitable nanofibers can also have a length to diameter ratio of from 10:1 to about 1000:1. In one embodiment, the length to diameter ratio is from about 10:1 to about 100:1. By contrast, nanofibers known in the art, including electrospun nanofibers, melt-blown nanofibers and microfiber-derived nanofibers (i.e., microfibers split during processing to obtain sub-micron diameter structures), typically have much greater length to diameter ratios in the range of 1,000,000:1 to 100,000,000:1. As a result, the nanofibers used in nanofiber filter media and filter devices disclosed herein can have from about 10 to about 1000 times more tips per unit length than electrospun nanofibers, melt blown nanofibers and microfiber derived nanofibers.

The related terms “nanofiber array” and “array of nanofibers,” which are used interchangeably herein, collectively refer to a plurality of freestanding nanofibers of user-defined physical dimensions and composition integrally formed on and extending from a backing member, such as a film, according to user-defined spatial parameters. In some embodiments, the nanofiber arrays disclosed herein include nanofibers which extend from a surface of the backing member at an angle substantially normal to a plane containing the surface of the backing member from which the nanofibers extend. By contrast, electrospun nanofibers, melt-blown nanofibers, and microfiber-derived nanofibers are neither integrally formed on nor do they extend from a backing member.

User-tunable physical characteristics of the nanofiber arrays disclosed herein include fiber spacing, diameter (also sometimes referred to herein as “width”), height (also sometimes referred to herein as “length”), number of fibers per unit of backing member surface area (also referred to herein as “fiber surface area density”), fiber composition, fiber surface texture, and fiber denier. For example, nanofiber arrays used in the filter media and filter devices disclosed herein can comprise millions of nanofibers per square centimeter of backing member, with fiber diameter, length, spacing, material composition, and texture configured to perform a filtration function. In some embodiments, one or more of fiber surface area density, diameter, length, spacing, composition, and texture are controlled and optimized to perform a filtration function. In certain embodiments, the nanofiber arrays can be optimized or “tuned” to perform a specific filtration function or target a preselected substance or specific retentate. In further embodiments, an array of nanofibers disposed on a portion of a filter lamina forming a flow passage of a filter device disclosed herein is configured to filter a substance from a fluid containing the substance when the fluid is flowed through the flow passage.

The nanofiber arrays disclosed herein, when formed on a substantially planar surface of a backing member, can include nanofibers spaced along an X-axis and a Y-axis at the same or different intervals along either axis. In some embodiments, the nanofibers can be spaced from about 100 nm to 200 micron or more apart on the X-axis and, or alternatively, the Y-axis. In certain embodiments, the nanofibers can be spaced from about 1 micron to about 50 micron apart on one or both of the X-axis and the Y-axis. In a preferred embodiment, the nanofibers can be spaced from about 2 micron to about 7 micron apart on one or both of the X-axis and the Y-axis.

In some embodiments, an array of nanofibers can include nanofibers having an average length of at least 25 micron. In certain embodiments, the nanofibers can have a length of from about 10 micron to about 100 micron. In certain embodiments, the nanofibers can have a length of from about 15 micron to about 60 micron. In an exemplar embodiment, the nanofibers can have an average length of from about 20 micron to about 30 micron. In specific embodiments, the nanofibers can have a length of about 15.00 micron, 16.00 micron, 17.00 micron, 18.00 micron, 19.00 micron, 20.00 micron, 21.00 micron, 22.00 micron, 23.00 micron, 24.00 micron, 25.00 micron, 26.00 micron, 27.00 micron, 28.00 micron, 29.00 micron, 30.00 micron, 31.00 micron, 32.00 micron, 33.00 micron, 34.00 micron, 35.00 micron, 36.00 micron, 37.00 micron, 38.00 micron, 39.00 micron, 40.00 micron, 41.00 micron, 42.00 micron, 43.00 micron, 44.00 micron, 45.00 micron, 46.00 micron, 47.00 micron, 48.00 micron, 49.00 micron, 50.00 micron, 51.00 micron, 52.00 micron, 53.00 micron, 54.00 micron, 55.00 micron, 56.00 micron, 57.00 micron, 58.00 micron, 59.00 micron, or 60.00 micron.

The nanofiber backing member surface area density can range from about 25,000,000 to about 100,000 nanofibers per square centimeter. In some embodiments, the nanofiber surface area density can range from about 25,000,000 to about 2,000,000 nanofibers per square centimeter. In specific embodiments, the nanofiber surface density is about 6,000,000 nanofibers per square centimeter. In an exemplar embodiment, the nanofiber surface area density is about 2,000,000 nanofibers per square centimeter.

In some embodiments, an array of nanofibers can include nanofibers having an average denier of from about 0.001 denier to less than 1.0 denier. In an exemplar embodiment, the nanofibers forming a nanofiber array disclosed herein can be less than one denier and have a diameter ranging from about 50 nm to about 1000 nm.

Nanofiber arrays and methods for producing nanofiber arrays suitable for use in the filter media and filter devices disclosed herein are described by the present inventors in US Patent Application Publication No. 2013/0216779, US Patent Application Publication No. 2016/0222345, and White et al., Single-pulse ultrafast-laser machining of high aspect nanoholes at the surface of SiO2, Opt. Express. 16:14411-20 (2008), each of which is incorporated herein by reference in its entirety.

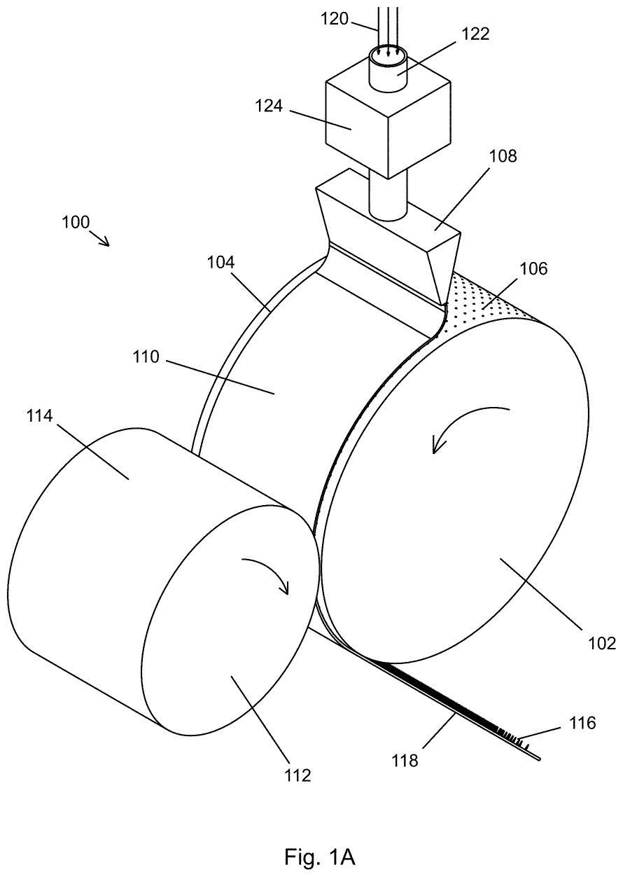

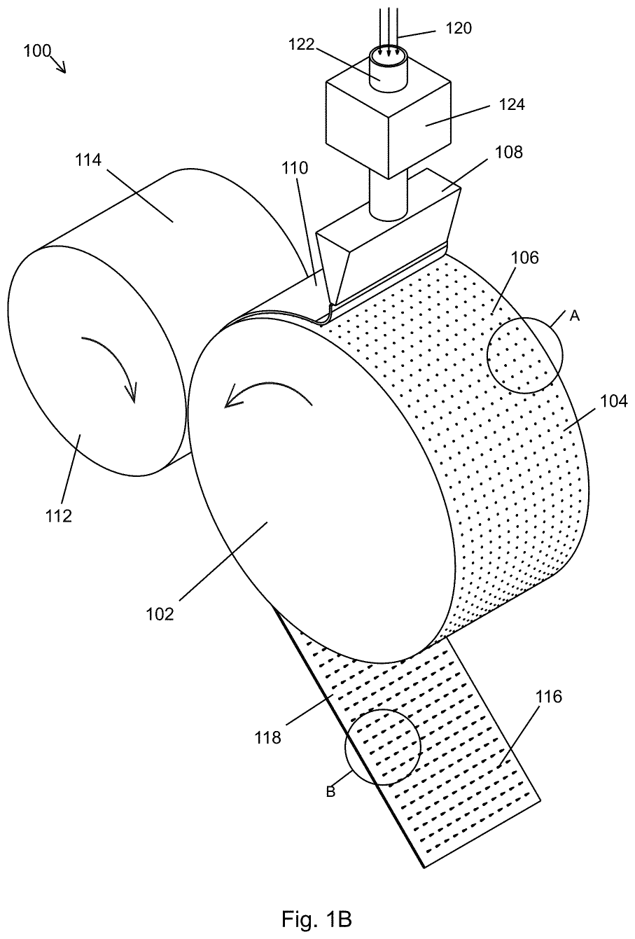

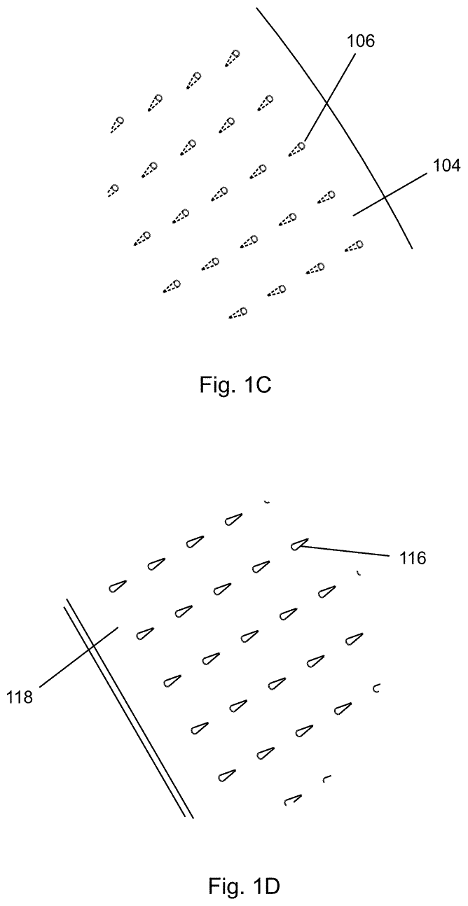

A preferred method for manufacturing laminae of the present invention has the ability to produce continuous elongate strips of film with arrays of nanofibers formed on at least one surface thereof. In method 100, a variation of a film producing technique referred to as “chill roll casting” and depicted in FIGS. 1A through 1D, polymer 120 is supplied via tubular member 122 to extrusion head 108. Polymer 120 is heated above its melt point by heater 124 and the melted polymer 110 is then applied to rotating cylindrical roll 102 (referred to as a “chill roll”) formed of silica or another suitable material. An array of nanoholes 106 is formed in the circumferential surface 104 of roll 102 so as to form a mold, the nanohole array being complementary to the array of nanofibers to be formed. The nanoholes are formed using methods previously described herein. Molten polymer 110 flows into nanoholes 106 as it is applied to circumferential surface 104 of rotating chill roll 102. Chill roll 102 is maintained at a temperature such that during a predetermined portion of the roll rotation of chill roll 102, polymer 110 in nanoholes 106 is cooled along with the portion of polymeric material 110 coating circumferential surface 104 of roll 102. A cylindrical metallic roll 112, commonly referred to as a “anvil roll” or “quench roll” functions as the compressing element and is positioned adjacent to chill roll 102 such that after a predetermined angular rotation of chill roll 102 polymeric material 110 coating the surface of chill roll 102 is compressed between surface 104 of chill roll 102 and surface 114 of the quench roll 112. As implied by the name “quench roll” polymeric material 110 undergoes rapid cooling during contact with quench/anvil roll 112 so that it may be subsequently stripped from the surface of chill roll 102 as a continuous elongate strip of film 118. When the polymer strip 118 is removed from chill roll 102, material 110 that had previously flowed into nanoholes 106 forms molded nanofibers 116 on the surface of film strip 118. Polymer 120 is not contained in a solution so the use of environmentally undesirable solvents is not required.

Under certain conditions, with suitable polymers, quench roll 112 is eliminated. The thickness of film strip 118 is determined by process parameters. These may include properties of polymer 120, the temperature of polymer 110 as it is deposited on surface 104 of chill roll 102, the temperature and rotational speed of chill roll 102, and other factors that affect the cooling of film strip 118. Under these conditions, material is drawn into nanoholes 106 of surface 104 of chill roll 102 by surface tension as a compressing element is not used.

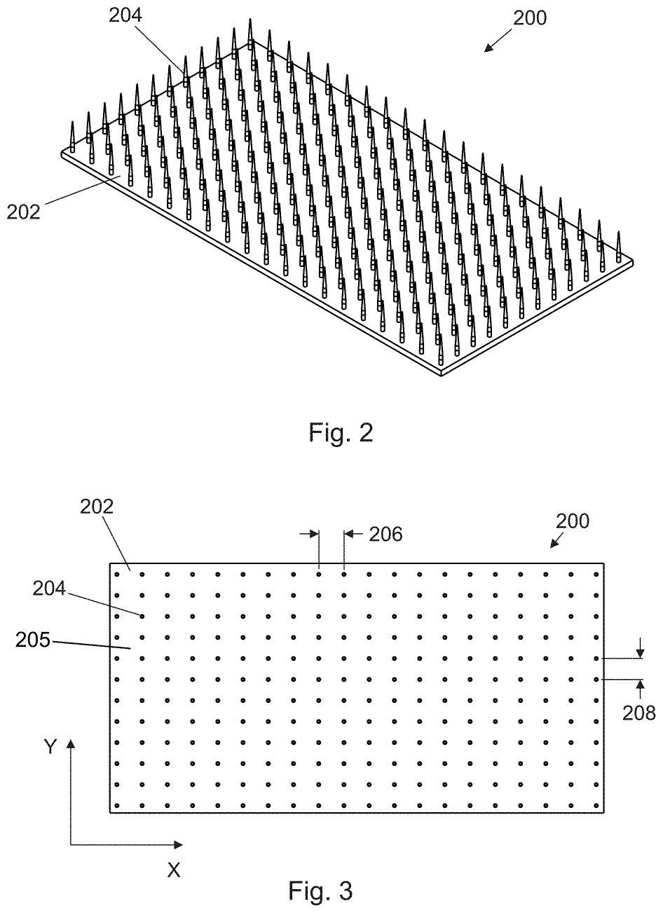

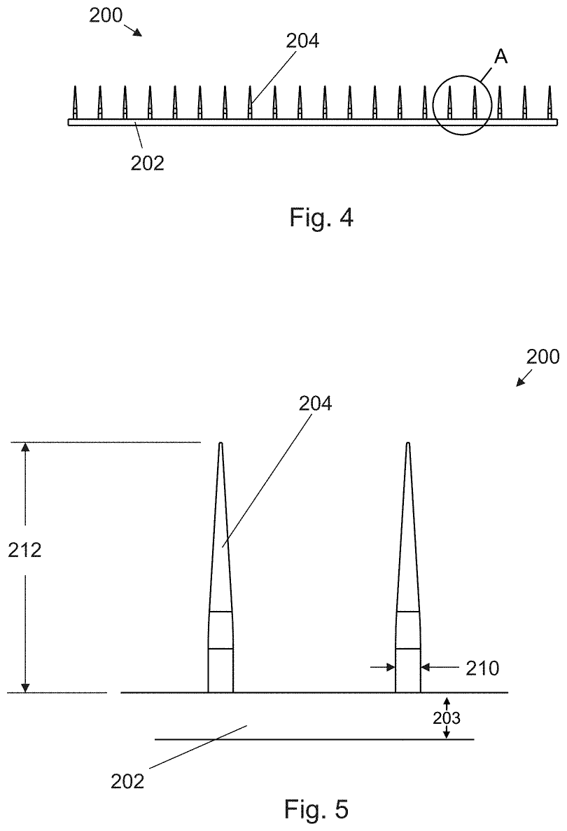

FIGS. 2 through 5 diagrammatically depict a segment of a filter media lamina 200 of the present invention. Lamina 200 has a flexibly planar film portion 202 having a thickness 203, with a first surface 205 on which are formed nanofibers 204. Nanofibers 204 have a first diameter 210 near the base of each fiber 204 and generally decrease in diameter toward the distal end of the fiber. Nanofibers 204 have a length 212 and are spaced a first distance 206 apart in a first direction and a second distance 208 apart in a second direction perpendicular to the first direction. Lamina 200 is depicted with first distance 206 and second distance 208 between adjacent nanofibers 204 constant over surface 205. In other embodiments, either distance 206 or distance 208 or both may vary along surface 205 of lamina 200. Nanofibers 204 are shown in ordered parallel rows. In other embodiments other arrangements are used depending on the particular filtering process requirements. Similarly, height 212 and diameter 210 of nanofibers 204 are constant across the surface of lamina 200. In other embodiments height 212 and diameter 210 of nanofibers on a first portion of surface 205 of lamina 200 may have first values, while on a second portion of surface 205, height 212 and diameter 210 may have second values.

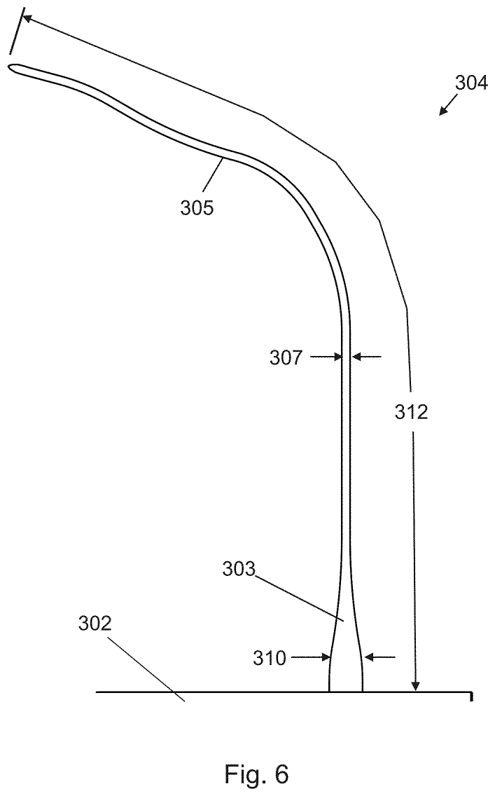

As defined herein the term “nanofiber” refers to a fiber structure having a diameter of less than 1000 nanometers for more than half the length of the structure. In some embodiments, the nanofibers of filter media of the present invention may have a tapered base portion and a relatively longer fiber portion which extends from the base portion. For example, as shown in FIG. 6, nanofiber 304 extends from planar film portion 302 and has a tapered proximal base portion 303 of diameter 310 with elongate distal portion 305 of diameter 307 formed thereon, and a length 312.

The process used to produce nanoholes 106 in chill roll 102 uses the energy of a single laser pulse to vaporize material so as to form the nanohole. The vaporized material of chill roll 102 is expelled to form a nanohole 106. The process is well controlled within limits, however the precise geometry of a nanohole 106 is determined by the flow of superheated vaporized material at the site. Accordingly, there may be minor variations in the form of nanoholes 106, and in the nanofibers 116 that are molded therein. Also, nanofibers 116, particularly those with long tendrilous forms, may stretch somewhat during extraction from nanoholes 106. Therefore, it will be understood that when it is stated that nanofibers in an array have a height, height is a nominal height, and individual fibers may have a height that is somewhat greater or less than nominal height. Similarly, when considering diameters of nanofibers, diameter is a nominal value and there may be natural variations in the diameters in nanofibers within an array.

Nanofibers of the present invention may be broadly characterized by the ratio of their length (212 in FIGS. 5 and 312 in FIG. 6) to their average diameter. Typically nanofibers of filter media of the present invention have length to diameter ratios between 10:1 and 1,000:1. Nanofibers with length to diameter ratios at the lower end of the range may be used in applications in which the fibers require a degree of stiffness to optimally affect a fluid stream flowing thereby.

The nanofiber arrays formed on filter laminae of the present invention may form a tuned topography. That is laminae may be optimally configured to remove specific contaminants such as pathogens, chemical contaminates, biological agents, and toxic or reactive compounds from a fluid to be filtered. By selecting specific values for longitudinal distance 206 and transverse distance 208 between adjacent nanofibers (FIGS. 2 through 5), and diameters 210 and 310, and lengths 212 and 312 of nanofibers 204 and 304 (FIGS. 5 and 6) laminae may be formed that preferentially remove a specific contaminant. Indeed, filtering devices may be formed in which laminae of a first configuration optimally designed for removal of a first contaminant are combined with laminae designed to remove a second contaminant. Additional laminae with tuned topographies for removing specific contaminants may be added to remove these substances from the flow stream. The laminae may be intermingled in a filter device, or formed in discrete layers each containing a single lamina configuration or a combination of two or more configurations.

Filter media laminae with nanofibers of the present invention may be formed from virtually any polymeric material. These polymeric materials have inherent electrostatic properties and exert an electrostatic force at a point on the surface of an object formed therefrom that is inversely related to the radius of curvature of the surface at that point. As the radius of the surface at a given point is reduced, the electrostatic attractive force at that point increases. Accordingly, the electrostatic force exerted by a nanofiber is much greater than that exerted by a microfiber. This is of particular importance in filter applications in which contaminants smaller than the pore size of the filter must be removed from a fluid stream. Electrostatic forces draw contaminants to fibers for removal from the fluid stream. As the diameter of the fibers is decreased, the electrostatic force exerted by the fibers increases. The attractive force of a nanofiber is generally orders of magnitude greater than that of a microfiber, and therein lies the incentive for creating nanofiber filters. The high level of electrostatic force exerted by nanofibers allows them to efficiently remove contaminants from a fluid stream.

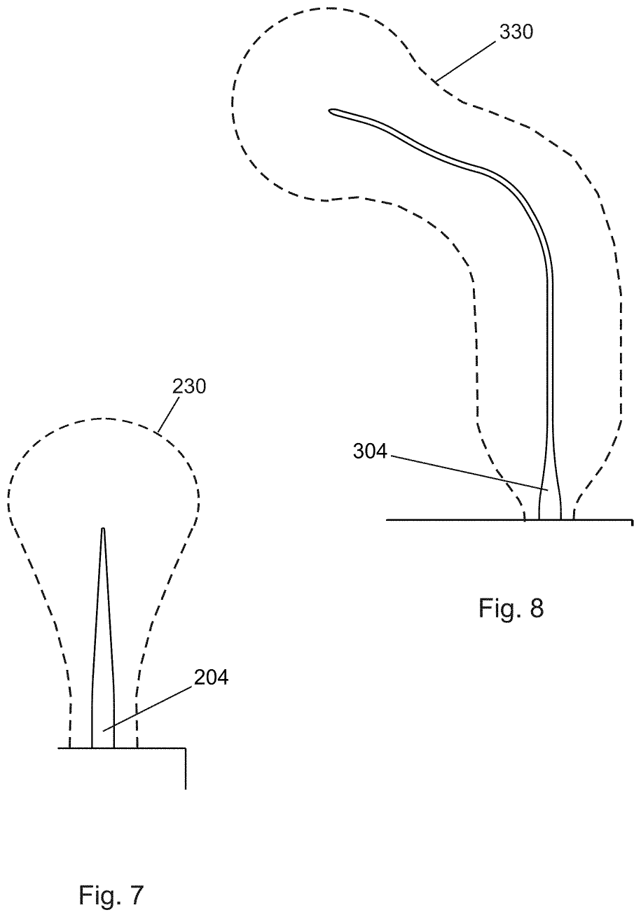

FIGS. 7 and 8 depict field lines 230 and 330 depicting the intensity of an electrostatic force field line surrounding nanofibers 204 and 304 respectively. As described previously, the field intensity at a point on the surface of a fiber is inversely proportional to the radius of curvature of the fiber at that point. This is reflected in the field line depicted. It should be noted that the field intensity is maximal at the distal end of the fibers. In prior art nanofiber filter medial formed by electrospinning or other conventional methods the nanofibers are virtually continuous with length to diameter ratios ranging from 1,000,000:1 to 100,000,000. Accordingly, for a given cumulative nanofiber length, fibers of the present invention will have from about ten to about one thousand times as many fiber ends. The associated higher electrostatic potential of nanofiber media formed in accordance with the present invention allows the construction of filters with efficiencies not attainable using nanofibers formed by electrospinning or other conventional methods.

The arrangement of nanofibers in an array can impact filtration specificity and efficiency by modulating the strong gradients in the electrical and chemical potential fields of normally highly reactive sub-micron length scale structures. Control of these gradients at process length scales can enhance efficiency of transport or flow. However, if two nanofibers are in close proximity and the potential fields overlap, then the gradient of the potential field is reduced and the advantages of the nanoscale topography are reduced. The arrangement of nanofibers in a nanofiber array of the proper scale and spacing will preserve the separation of nanofibers thus optimizing the potential field gradient.

An electrostatic charge may be imparted to the filter media of the present invention to increase the attractive force of the nanofiber arrays formed on laminae. Filter laminae of the present invention may be formed from a polymer or polymer blend with suitable electret properties. Among these materials are polypropylene, poly(phenylene ether) and polystyrene. In certain embodiments these laminae may have a lamellar construction that has a first layer formed of an electret material on which are formed nanofiber arrays of the present invention, and a second layer bonded thereto with desirable physical and/or electrical properties. The materials selected for each layer may be optimized for a specific filtering application. Charging of the media may be accomplished by corona discharge, triboelectrification, polarization, induction, or another suitable method. Over time the imparted electrostatic charge may be dissipated by particle loading, and/or by quiescent or thermal stimulation decay.

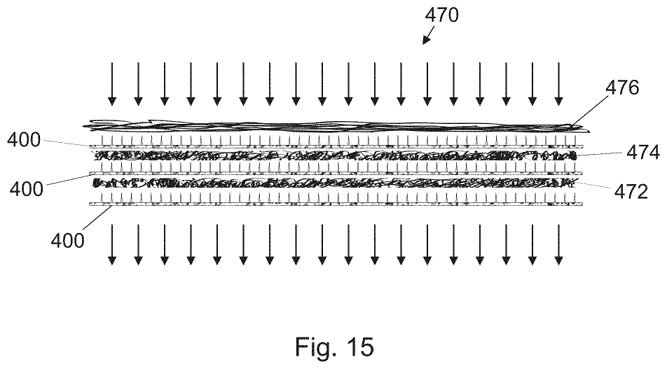

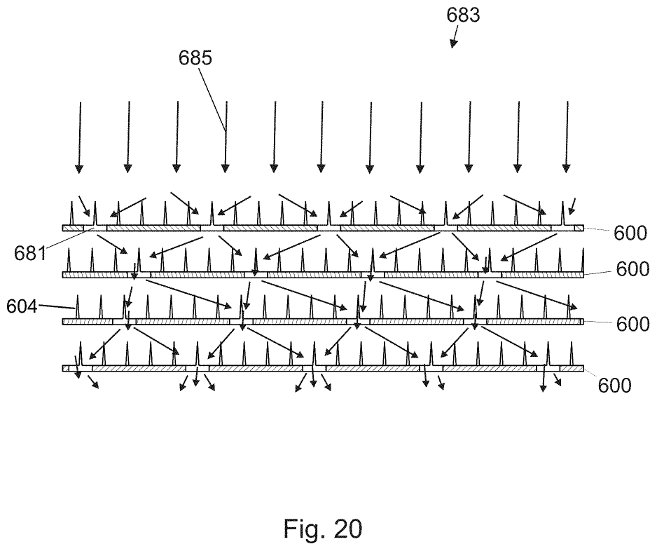

Filter laminae of the present invention have a controlled permeability so that fluid flow passes through the plane of the laminae (see, e.g., FIGS. 15 and 20 for an example of flow through the plane of the laminae). After the film material with nanofibers arrays is formed according to methods previously herein described, pores or perforations are formed in the laminae. In some embodiments, perforations are formed by mechanical punching; in others by slitting and lateral stretching of the material so that the slits form openings in the film; and in still others the film is formed of a polymeric material with properties that allow the pores to be formed by stretching or other mechanical or non-mechanical methods.

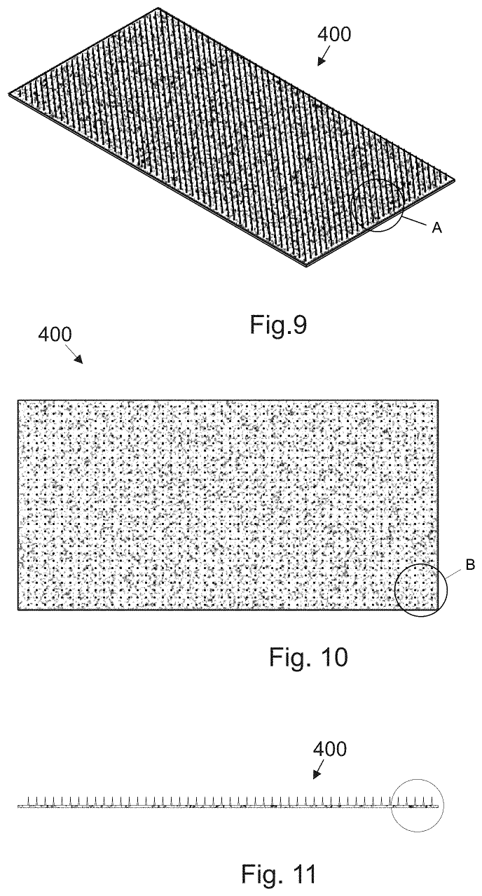

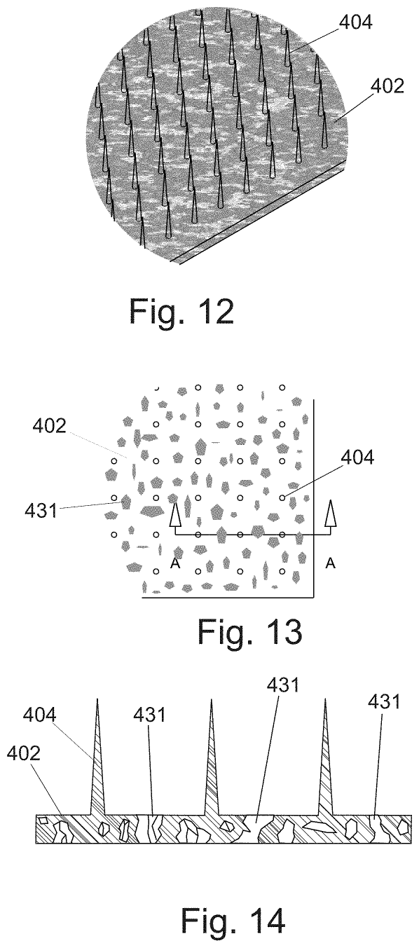

For instance, permeable lamina 400 depicted in FIGS. 9 through 14 is identical in all aspects of form and function to lamina 200 (FIGS. 2 through 5) except as subsequently herein described. Lamina 400 is formed of a polymeric material in which pores 431 are formed in film portion 402 by methods known in the art that do not included mechanical perforation. Pores 431 are distributed throughout film portion 402, and, as depicted in FIG. 14, provide a path for filtrate to permeate film portion 402 of lamina 400. In use, filter media including laminae 400 are positioned in a fluid stream wherein the fluid is exposed to nanofibers 404 before passing through pores 431 as filtrate. In preferred embodiments fluid upstream from lamina 400 is turbulent so as to maximize the portion of the flow that brings contaminant within capture distance of the electrostatic forces of nanofibers 404 before flowing through pores 431.

Referring now to FIG. 15, media construct 470 comprises laminae 400 separated by turbulence inducing layers 472, 474, and 476. In a preferred embodiment layers 472, 474 and 476 are formed of filter ribbons as taught by Hofmeister et al., in US Patent Application Publication Nos. 2020/0368655 and 2020/00368656. Lamina 400 may all have identical arrays of nanofibers 404, or each may have a unique configuration optimized for the removal of a specific contaminant.

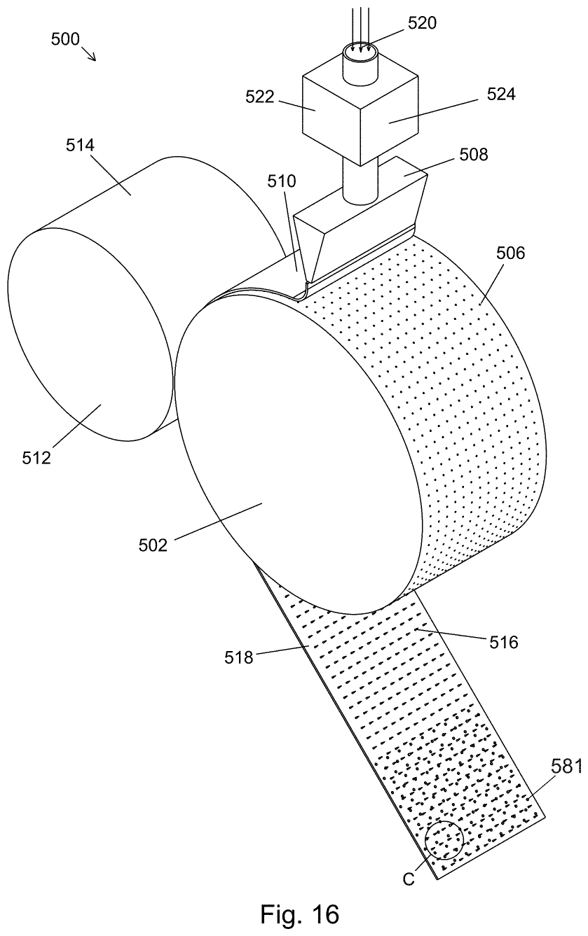

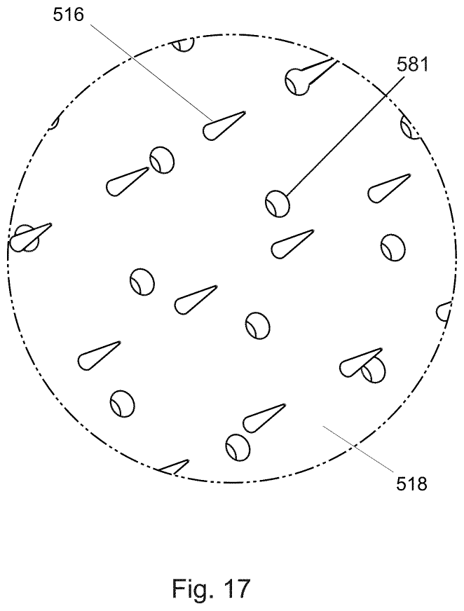

In other embodiments of the present invention, perforations are formed in nanofiber bearing film mechanically by punching or piercing. FIGS. 16 and 17 depicts a system for producing nanofiber bearing film of the present invention wherein perforations are automatically formed. System 500 is identical to system 100 in all aspects of form and function except as subsequently described herein. System 500 has a perforating system that creates perforations 581 in film 518 with nanofibers 516. In a preferred embodiment, perforations 581 are formed by continuous cutting method in which film 518 passes between two rotating rolls. A first roll with a featureless circumferential surface supports film 518. A second roll has sharpened circular protrusions formed on its circumferential surface. As film 518 passes between these first and second rolls, the circular protrusions act as punches to remove a circular segment of film to form perforations 581. System 500 has a perforation forming mechanism integrated into system 500. In other embodiments, perforations are formed in a secondary punching operation performed after film 518 is removed from system 500. Any method for forming perforations 581 in film 518 falls within the scope of this invention.

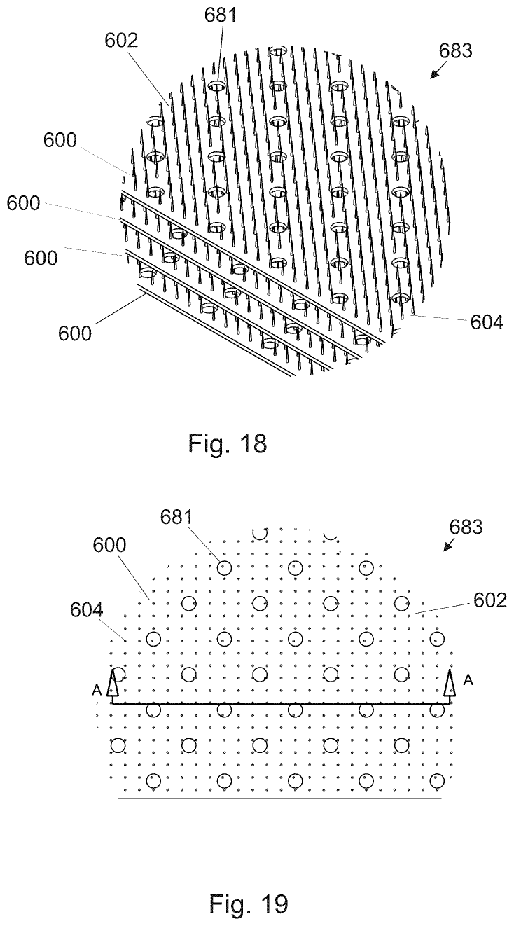

Multiple laminae in which perforations have been formed may be assembled to form filter media of the present invention. For example, FIGS. 18 and 19 depict a segment 683 of a filter element comprised of four laminae 600 in which multiple perforations 681 are formed, and FIG. 20 depicts the flow of a fluid 685 depicted by arrows through filter segment 683. Laminae 600 depicted in FIGS. 18-20 are identical in all aspects of form and function to lamina 200 (FIGS. 2 through 5), except as herein described. Perforations 681 in laminae 600 and the interlaminar spaces between laminae 600 form a labyrinth through which fluid 685 must flow. This flow path exposes fluid 685 to nanofibers 604 formed on the surface of the film portion 602 of laminae 600. Preferably, flow through the interlaminar spaces is turbulent so as to maximize the portion of fluid 685 that passes in sufficiently close proximity to nanofibers 604 for the electrostatic force of nanofibers 604 to capture the contaminant and remove it from the fluid stream. The interlaminar space between laminae 600 may be maintained by protrusions (not shown) formed on laminae 600, or more preferably, by placing turbulence inducing media between laminae 600. Turbulence in the interlaminar spaces may be favorably affected by the size, placement and density of the perforations 681 formed on the laminae.

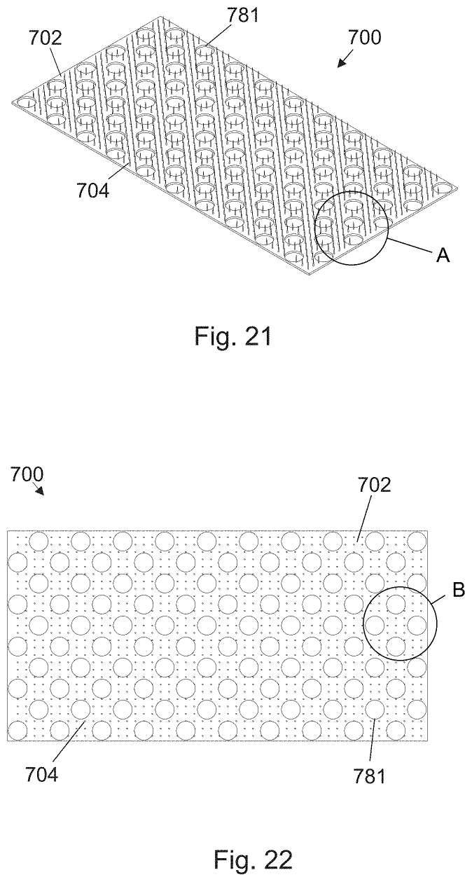

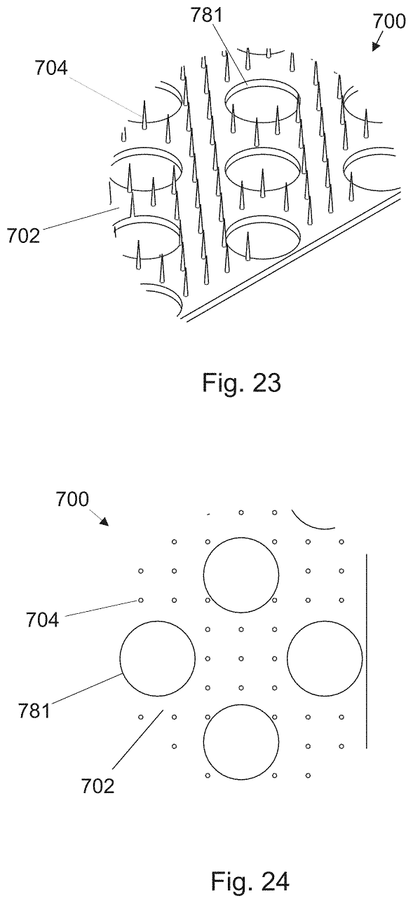

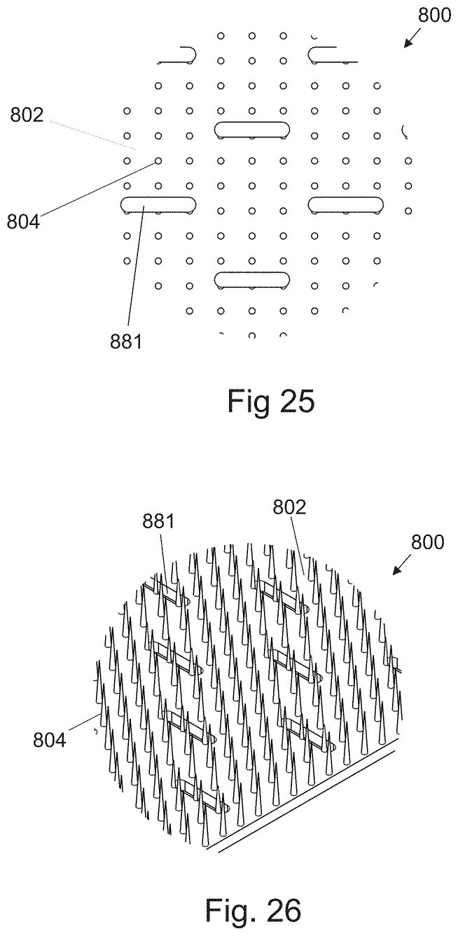

FIGS. 21 through 24 depict a portion of laminae 700 in which the diameter of the perforations 781 has been increased so as to affect the flow velocity between laminae 700. In all other aspects, lamina 700 is identical to lamina 600. Interlaminar turbulence may also be affected by the shape of perforations 781 formed in the laminae. FIGS. 25 and 26 depict lamina 800 in which perforations 881 have the form of elongate slots. The shape and size of perforations in laminae of the present invention are features that may be optimized for specific filtering applications. Any perforation that provides flow from a first side of the lamina to the opposite side of the lamina falls within the scope of this invention.

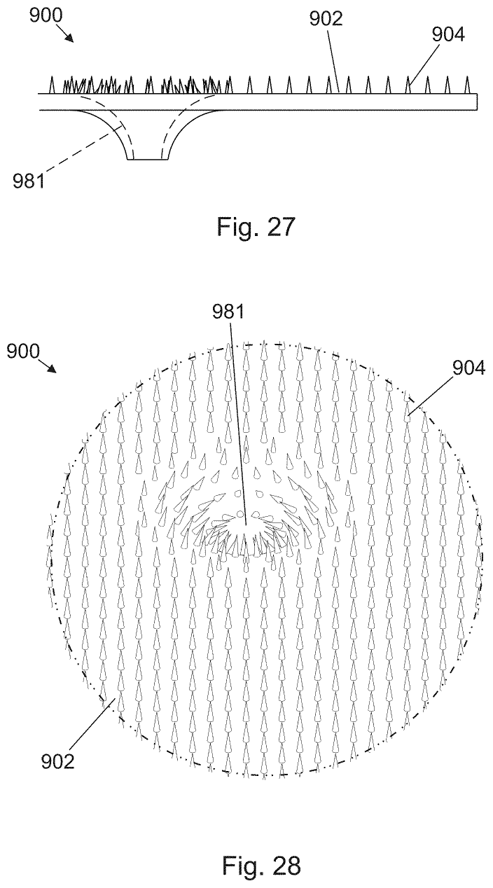

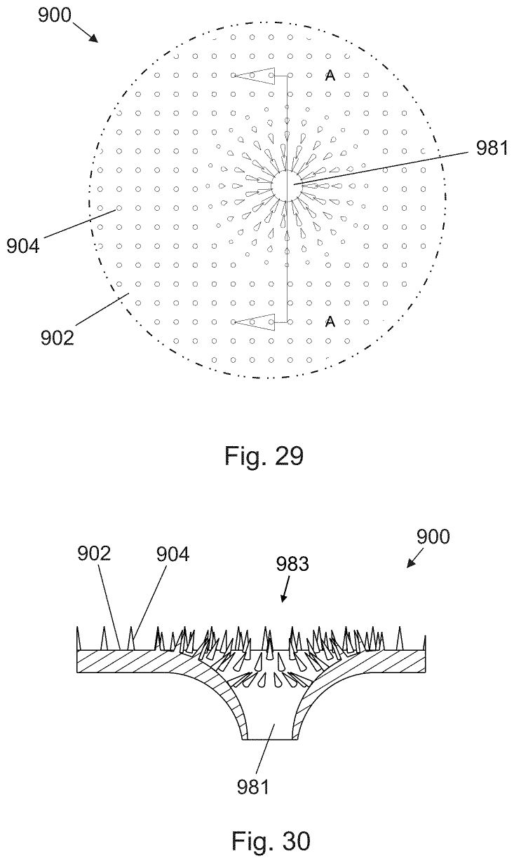

Perforations in laminae 500 through 800 are formed by removing a discreet portion of the film of predetermined shape and size. In other embodiments the perforations are formed by piercing the film with a sharpened tool that does not remove a portion of the film. FIGS. 27 through 30 depict a perforation formed in a lamina 900 using a sharpened tool that does not remove a segment of lamina 900. Perforation 981 is formed by deformation of planar film portion 902. As best seen in FIG. 30, this deformation creates portions adjacent to perforation 981 in which nanofibers 904 are concentrated in the upstream approach 983 to perforation 981. This increases the likelihood that contaminant in the fluid stream will pass within capture distance of a nanofiber 904. Additionally, turbulence is created by the transition from perforation 981 to the interlaminar space between adjacent laminas when a plurality of laminas including a lamina 900 are formed into a filter media construct. Perforations 981 may be formed in a piercing operation by tooling designed specifically for this purpose. This deformation may also be created when a plurality of laminae 900 are assembled into a filter media construct using needling, a joining process for sheet materials of various types. As with previous embodiments, lamina 900 may be combined with other media in constructs previously herein described.

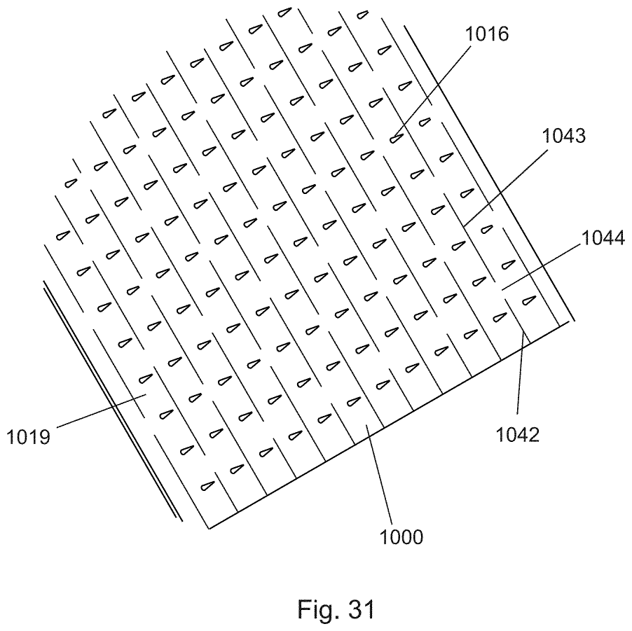

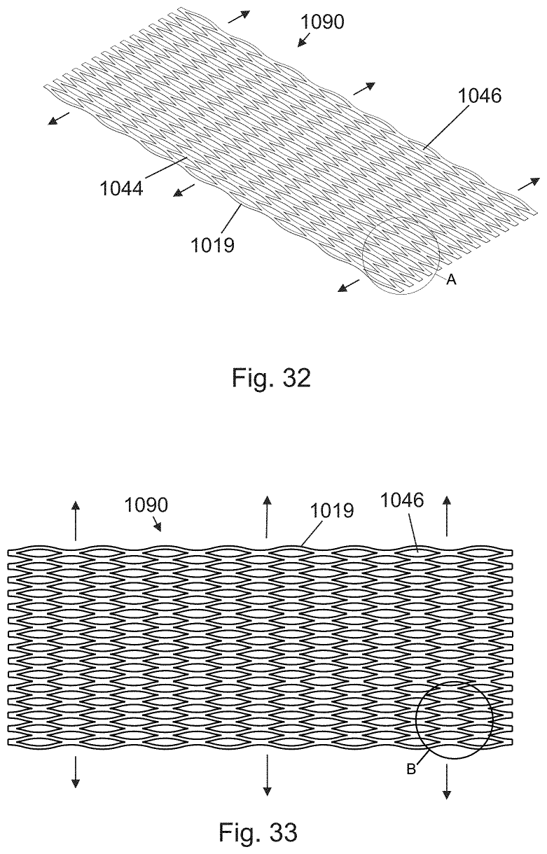

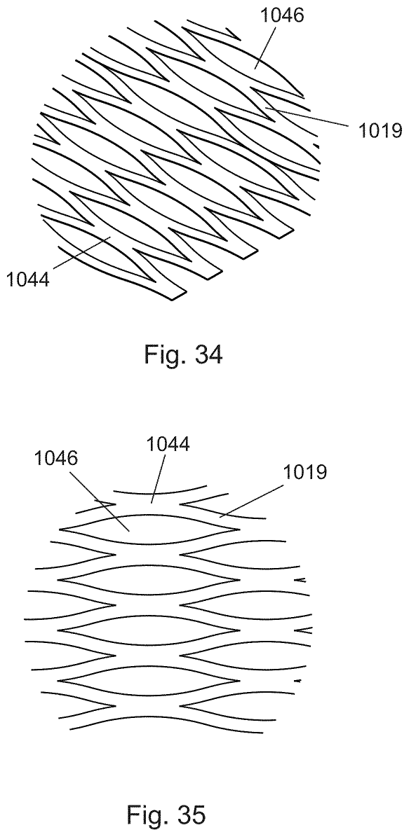

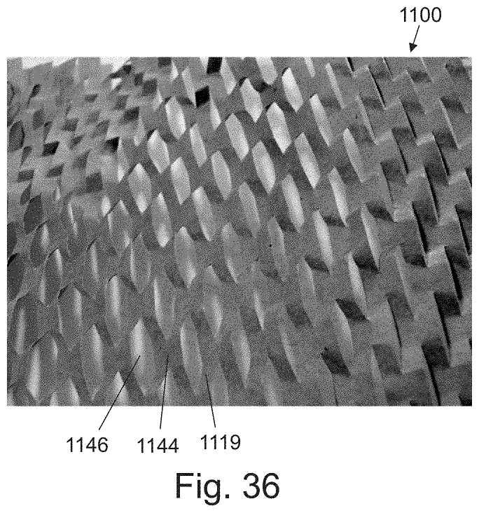

Openings in laminae of the present invention may also be formed by creating interrupted longitudinal slits in the film and then subjecting the film to a lateral spreading force. FIG. 31 depicts a portion of a film strip 1000 for forming a lamina of the present invention. Longitudinal slits 1042, 1043 are separated longitudinally by film portions 1044. Longitudinal slits 1042, 1043 are centered on laterally adjacent film portions 1044. Nanofibers 1016 can be centered between adjacent longitudinal slits 1042, 1043. Longitudinally extending film strip portions 1019 are bound on its sides by slits 1042, 1043 and film portion 1044. Applying a lateral stretching force to the edges of film 1000 as indicated by arrows in FIGS. 32 and 33 causes longitudinal slits 1042, 1043 to spread so as to create openings 1046 in film 1000, film 1000 now forming a mesh 1090. As best seen in FIGS. 34 and 35, openings 1046 are bound by longitudinally extending film strip portions 1019. Expanding film 1000 to form a mesh 1090 is accomplished by deformation of film strip portions 1019. This is not limited to deformation solely within the plane of film 1000, but also involves twisting of film strip portions 1019. In certain embodiments this deformation is controlled so as to create specific mesh geometries optimized for forming filter media for specific filtering applications. For instance, FIG. 36 depicts a mesh 1100 formed from a film portion with intermittent slits in the manner previously described. Deformation of portions 1119 is controlled so that portions 1119 are angularly offset from the basal plane of mesh 1100. In other words, portions 1119 of mesh 1100 are no coplanar with the overall basal plane of the 1100. In meshes 1100, the angular offset of portions 1119 increases as the width of openings 1146 is increased. These aspects of the configuration of mesh 1100 may be optimized for specific filter applications. Multiple meshes 1100 may be stacked one upon another so as to create filter media in which meshes 1100 create significant turbulence so as to increase filter efficiency.

Laminae of the present invention may be used in layered constructs with other media types. These constructs, may form composite sheets. These sheets may, in turn, be formed into configurations optimized for specific applications. For instance, these composite sheets may be formed into pleated filter elements.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention, it is not intended that such references be construed as limitations upon the scope of this invention except as set forth in the following claims.

1. A flexible filter media construct, comprising:
a plurality of flexible laminas joined in a stack, each lamina including an array of nanofibers extending from a surface thereof and a plurality of perforations extending therethrough;
wherein said laminas are arranged in the stack such that a fluid flowed into the construct can flow through the perforations of each successive lamina in the stack and in any direction across the surface of each successive lamina in the stack as the fluid flows through the construct.

2-4. (canceled)

5. The flexible filter media construct of claim 1, wherein:
the perforations are funnel-shaped;
each perforation includes a concave upstream approach adjacent thereto; and
the surface of each lamina from which extends the array of nanofibers forms at least a portion of the upstream approach of each perforation.

6. The flexible filter media construct of claim 1, wherein the perforations are uniformly distributed across the surface of each lamina.

7. The flexible filter media construct of claim 1, wherein the perforations are formed by a method which removes a segment of material from the laminas.

8. The flexible filter media construct of claim 1, wherein the perforations are formed by a method which does not remove a segment of material from the laminas.

9. The flexible filter media construct of claim 8, further comprising a concavity formed in the surface of each lamina around each respective perforation.

10. The flexible filter media construct of claim 1, wherein each lamina of the plurality of laminas supports or is supported by another lamina of the plurality.

11. The flexible filter media construct of claim 1, further comprising a flexible turbulence-inducing layer arranged between two adjacent laminas of the plurality of laminas.

12. The flexible filter media construct of claim 11, wherein each lamina of the plurality of laminas supports or is supported by either another lamina or the flexible turbulence-inducing layer.

13-17. (canceled)

18. A flexible filter media construct, consisting of:
a plurality of laminas joined in a stack, each lamina including a flexible film portion having a surface and an array of nanofibers extending from the surface; and
a plurality of uniformly distributed openings defined through the film portion of each lamina such that a fluid flowed through the construct can flow through the openings normal to the surface of the film portion and in any direction along the surface of the film portion of each lamina;
wherein a contaminant contained in the fluid is at least partially filtered from the fluid by the nanofibers when the fluid is flowed along the surface or into or through the perforations.

19-20. (canceled)

21. A flexible filter media construct, comprising:
a plurality of flexible laminas joined in a stack, each lamina including:
a first surface,
a second surface,
an array of nanofibers extending from the first surface, and
a plurality of perforations extending from the first surface to the second surface;
wherein the lamina stack defines a fluid flow path extending in every direction across the surface of each successive lamina in the stack and through the perforations of each successive lamina in the stack.

22. The flexible filter media construct of claim 21, wherein the perforations extending through each lamina are uniformly distributed across the first surface of each lamina.

23. The flexible filter media construct of claim 22, wherein the laminas are arranged in the stack such that the perforations of any two adjacent laminas in the stack do not align.

24. The flexible filter media construct of claim 21, wherein:
the perforations are funnel-shaped; and
the first surface of each lamina from which extends the array of nanofibers defines a concave deformation surrounding each respective perforation.

25. The flexible filter media construct of claim 21, wherein each lamina of the plurality of laminas supports or is supported by another lamina of the plurality.

26. The flexible filter media construct of claim 21, further comprising a flexible turbulence-inducing layer arranged between two adjacent laminas of the plurality of laminas.

27. The flexible filter media construct of claim 26, wherein each lamina of the plurality of laminas supports or is supported by either another lamina or the flexible turbulence-inducing layer.
